(19) United States
(12) Patent Application Publication
(10) Pub. No.: US 2011/0286834 A1
(43) Pub. Date: Nov. 24, 2011

(54) GUIDE VANE FOR A GAS TURBINE

(75) Inventors: Brian Kenneth WARDLE, Brugg (CH); Andre SAXER, Mellingen (CH); Beat VON ARX, Trimbach (CH); Igor TSYPKAYKIN, Turgi (CH)

(73) Assignee: ALSTOM TECHNOLOGY LTD, Baden (CH)

(21) Appl. No.: 13/116,138

(22) Filed: May 26, 2011

Related U.S. Application Data
(63) Continuation of application No. PCT/EP2009/065210, filed on Nov. 16, 2009.

(30) Foreign Application Priority Data
Nov. 26, 2008 (CH) 01845/08

(51) Int. Cl. F03B 11/00

(52) U.S. Cl. 415/115

(57) ABSTRACT

A guide vane is provided for a gas turbine and has an airfoil extending in the radial direction between an inner platform and an outer platform. The airfoil extends transversely to the direction of the hot gas flow between a leading edge and a trailing edge and has a pressure side and a suction side. A cooling slot running parallel to the trailing edge is provided on the pressure side in front of the trailing edge, a cooling medium can exit through the cooling slot from the guide vane over the entire length of the guide vane and can cool the trailing edge of the guide vane. In such a guide vane, the service life is extended by a thermal stress reducing element provided on the inner platform below the trailing edge and the cooling slot.

### CROSS REFERENCE TO RELATED APPLICATIONS

This application is a continuation of International Application No. PCT/EP2009/065210 filed Nov. 16, 2009, which claims priority to Swiss Patent Application No. 01845/08, filed Nov. 26, 2008, the entire contents of all of which are incorporated by reference as if fully set forth.

### FIELD OF INVENTION

The present invention relates to the field of gas turbine technology. Specifically, it concerns a guide vane for a gas turbine.

### BACKGROUND

Gas turbines with sequential combustion are known and have proven successful in industrial use.

Such a gas turbine, known in specialist circles as GT24/26, can be seen, for example, from the article by Joos, F. et al., “Field Experience of the Sequential Combustion System for the ABB GT24/GT26 Gas Turbine Family”, IGTI/ASME 98-GT-220, 1998 Stockholm. FIG. 1 thereof shows the basic construction of such a gas turbine, the FIG. 1 thereof being reproduced in the present application as FIG. 1. Furthermore, such a gas turbine can be found in U.S. Pat. No. 5,454,220, which is incorporated by reference.

FIG. 1 shows a gas turbine 10 with sequential combustion, in which a compressor 11, a first combustion chamber 14, a high pressure turbine (HPT) 15, a second combustion chamber 17 and a low pressure turbine (LPT) 18 are arranged along an axis 19. The compressor 11 and the two turbines 15, 18 are part of a rotor which rotates about the axis 19. The compressor 11 draws in air and compresses it. The compressed air flows into a plenum and flows from there into premix burners, where this air is mixed with at least one fuel, at least fuel fed via the fuel supply 12. Such premix burners are found in principle in U.S. Pat. Nos. 4,932,861 or 5,588,826, which are incorporated by reference.

The compressed air flows into the premix burners, where the mixing, as stated above, takes place with at least one fuel. This fuel/air mixture then flows into the first combustion chamber 14, into which this mixture passes for the combustion while forming a stable flame front. The hot gas thus resulting is partly expanded in the adjoining high pressure turbine 15 to perform work and then flows into the second combustion chamber 17, where a further fuel supply 16 takes place. Due to the high temperatures which the hot gas partly expanded in the high pressure turbine 15 still has, a combustion which is based on self-ignition takes place in the second combustion chamber 17. The hot gas re-heated in the second combustion chamber 17 is then expanded in a multistage low pressure turbine 18.

The low pressure turbine 18 comprises a plurality of rows of moving blades and guide vanes which are arranged alternately one behind the other in the flow direction. The guide vanes of the third guide vane row in the direction of flow are provided with reference numeral 20′ in FIG. 1.

At the high hot gas temperatures in gas turbines of the new generations, it has become essential to cool the guide vanes and moving blades of the turbine in a sustainable manner. To this end, a gaseous cooling medium (for example compressed air) is branched off from the compressor of the gas turbine or steam is supplied. In all cases, the cooling medium is passed through cooling channels formed in the vane or blade (frequently running in serpentine shapes) and/or is directed outward through appropriate openings (bores, slots) at various points on the vane or blade in order to form a cooling film in particular on the outer side of the vane or blade (film cooling). An example of such a cooled vane or blade is described and represented in U.S. Pat. No. 5,813,835, which is incorporated by reference.

Within the context of vane cooling, the trailing edge of the vane is frequently also cooled in that cooling medium is ejected through a slot-like opening (cooling slot) arranged on the pressure side of the vane in front of the trailing edge and running substantially parallel to the trailing edge, and sweeps over the trailing edge and the region of the vane surface situated between the opening and trailing edge. Such a cooling of the trailing edge is represented in FIG. 3 of U.S. Pat. No. 5,813,835 by reference numerals 208 and 210.

The guide vane 20′ according to FIG. 1 has an airfoil extending in the radial direction between an inner platform and an outer platform, wherein the airfoil extends transversely to the direction of the hot gas flow with a pressure side and a suction side between a leading edge and a trailing edge, and a cooling slot of the above-described type running parallel to the trailing edge is provided on the pressure side in front of the trailing edge, through which cooling slot a cooling medium can exit from the guide vane over the entire length of the guide vane and cool the trailing edge of the guide vane.

Due to the cooling slot which is integrated into the airfoil and which is produced in particular by casting, the trailing edge of the guide vane must be made comparatively thin. If in operation the inner platform of the guide vane, which butts against the rotor as a result of sealing, is exposed to the loading which occurs, considerable mechanical forces are consequently exerted on the trailing edge of the airfoil which, on account of the low thickness of the trailing edge, can lead to cracks at the connection point between the trailing edge and inner platform and hence an undesired limiting of the service life.

### SUMMARY

The present disclosure is directed to a guide vane, for a gas turbine, and including an airfoil extending in a radial direction between an inner platform and an outer platform. The airfoil extends transversely to a hot gas flow direction between a leading edge and a trailing edge and has a pressure side and a suction side. A cooling slot running parallel to the trailing edge is provided on the pressure side in front of the trailing edge. A cooling medium flows through the cooling slot out of the guide vane over an entire length of the guide vane and thus cools the trailing edge of the guide vane. A thermal stress reducing element is provided on the inner platform below the trailing edge and the cooling slot.

### BRIEF DESCRIPTION OF THE DRAWINGS

The invention will be explained in more detail below with reference to exemplary embodiments in conjunction with the drawing. All the elements not essential for directly understanding the invention have been omitted. The same elements are provided with the same reference numerals in the various figures. The flow direction of the media is indicated by arrows. In the drawings:

FIG. 1 shows the basic construction of a gas turbine with sequential combustion according to the prior art;

FIG. 2 shows, in a perspective side view, a guide vane for the third guide vane row in the low pressure turbine of a gas turbine with sequential combustion according to FIG. 1 according to a preferred exemplary embodiment of the invention;

FIG. 3 shows another perspective side view of the vane from FIG. 2;

FIG. 4 shows, in a detail, a view of the inner platform counter to the flow direction (IV in FIG. 2);

FIG. 5 shows the section through the inner platform in the plane V-V in FIG. 4, and

FIG. 5a shows the main cross-sectional profile of the slot in the inner platform.

### DETAILED DESCRIPTION OF THE PREFERRED EMBODIMENTS

### Introduction to the Embodiments

It is therefore the object of the invention to provide a guide vane of the type mentioned at the outset in which the disadvantages of the previous solution are avoided and which is distinguished as a whole by a service life which is not compromised by the thin trailing edge.

The object is achieved by all the features of claim 1. It is preferable for the solution according to the invention that the thermal stresses are reduced by providing elements on the inner platform below the trailing edge and the cooling slot. These elements ensure that, without changing the vane geometry, in particular without increasing the wall or material thicknesses, it is possible through a “decoupling” between the inner platform and vane trailing edge to favorably influence the service life of the guide vane.

According to a preferred embodiment of the invention, the thermal stress reducing elements comprise a slot running through the inner platform and which is oriented, in particular, substantially parallel to the plane of the inner platform and has a cross-sectional profile in the form of a keyhole, with a wall section with parallel sides and a round, in particular circular, end section arranged on the bottom of the slot.

In another embodiment, the inner platform has a four-cornered base surface, the trailing edge with the cooling slot arranged in front leads into the inner platform at one of the four corners, and the slot intersects this corner. Preferably, the end section of the slot here encloses an acute angle, in particular an angle between 30° and 40° , with the side walls of the inner platform.

The slot has a width of less than 1 mm in the region of the wall section, and the end section is formed in a circular manner with a radius greater than 1 mm. In particular, the slot has a width of about 0.4 mm in the region of the wall section, and the end section is formed in a circular manner with a radius of about 1.25 mm.

According to a further embodiment of the invention, the cooling slot is produced in the guide vane by casting.

The guide vane according to the invention is advantageously used in a gas turbine, wherein the guide vane is arranged in a turbine of the gas turbine.

Here, the gas turbine is preferably a gas turbine with sequential combustion which has a first combustion chamber with a downstream high pressure turbine and a second combustion chamber with a downstream low pressure turbine, wherein the guide vane is arranged in the low pressure turbine. In particular, the low pressure turbine has a plurality of rows of guide vanes one behind another in the flow direction, and the guide vane is arranged in a central guide vane row.

### DETAILED DESCRIPTION

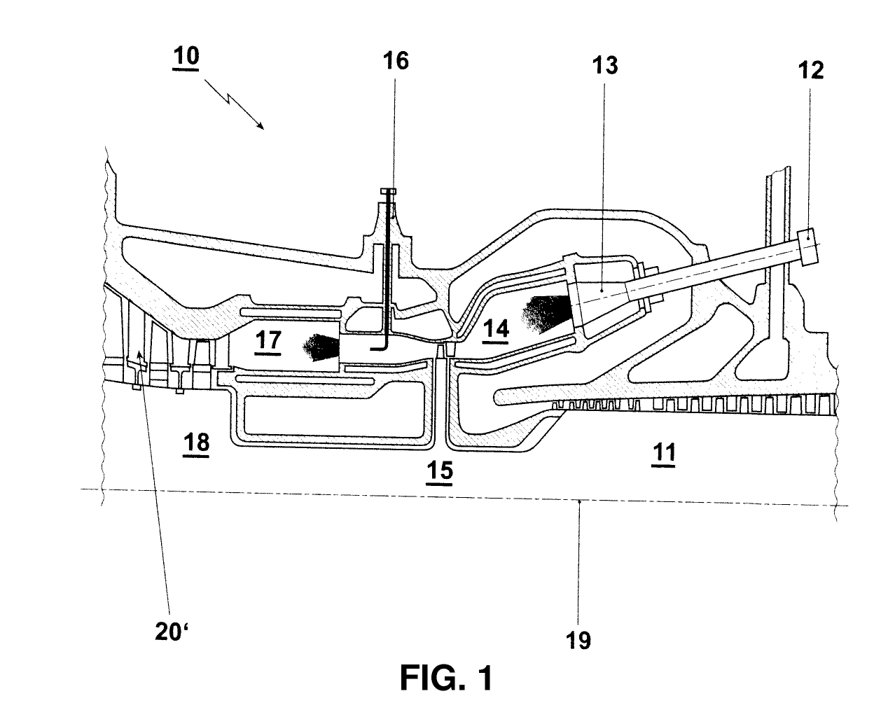

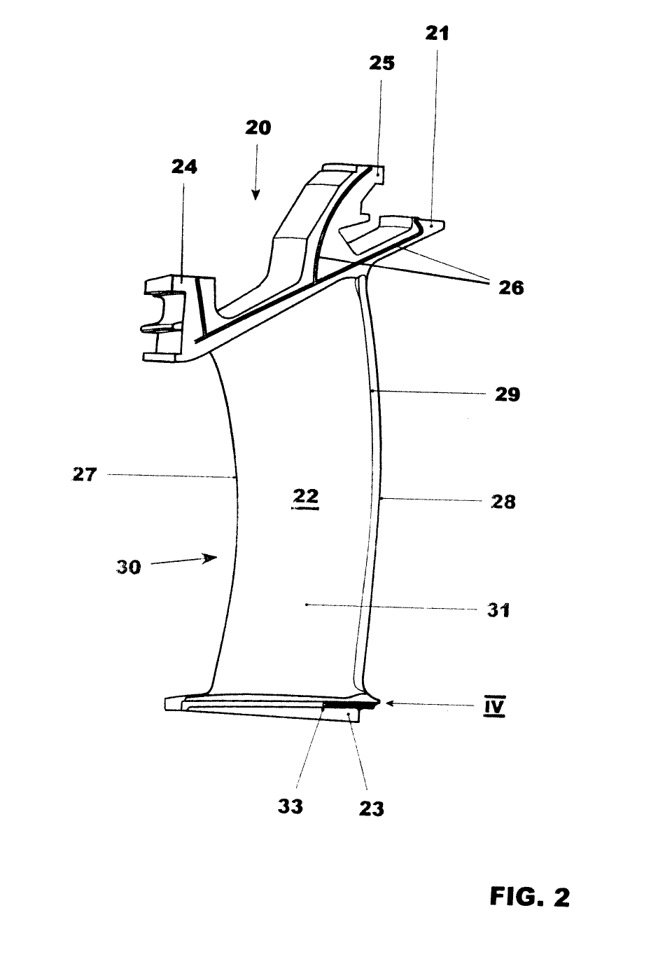

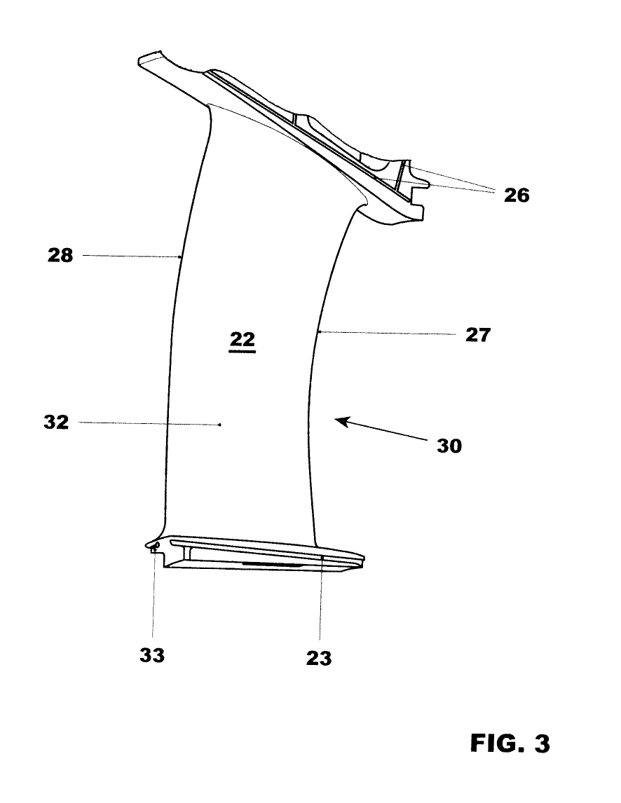

FIGS. 2 and 3 depict, in different perspective side views, a guide vane for the third guide vane row in the low pressure turbine of a gas turbine with sequential combustion according to FIG. 1 according to a preferred exemplary embodiment of the invention. The guide vane 20 comprises a spatially curved airfoil 22 which extends in the longitudinal direction (in the radial direction of the gas turbine) between an inner platform 23 and an outer platform 21 and reaches in the direction of the hot gas flow 30 from a leading edge 27 up to a trailing edge 28. Between the two edges 27 and 28, the airfoil 22 is bounded outwardly by a pressure side 31 (facing the viewer in FIG. 2) and an (opposite) suction side 32 (facing the viewer in FIG. 3). A cooling slot 29 running parallel to the trailing edge 28 is arranged just in front of the trailing edge 28 on the pressure side 31, cooling air passes through the cooling slot from the vane interior to the outside and cools the vane region between cooling slot 29 and trailing edge 28 and the trailing edge 28 itself. The guide vane 20 is mounted on the turbine casing by means of the hook-like mounting elements 24 and 25 formed on the upper side of the outer platform 21, whereas it bears with the inner platform 23 against the rotor in a sealing manner. Sealing grooves 26 which accommodate strip seals for sealing the gaps between adjacent guide vanes are arranged in the lateral surfaces of the outer platform 21.

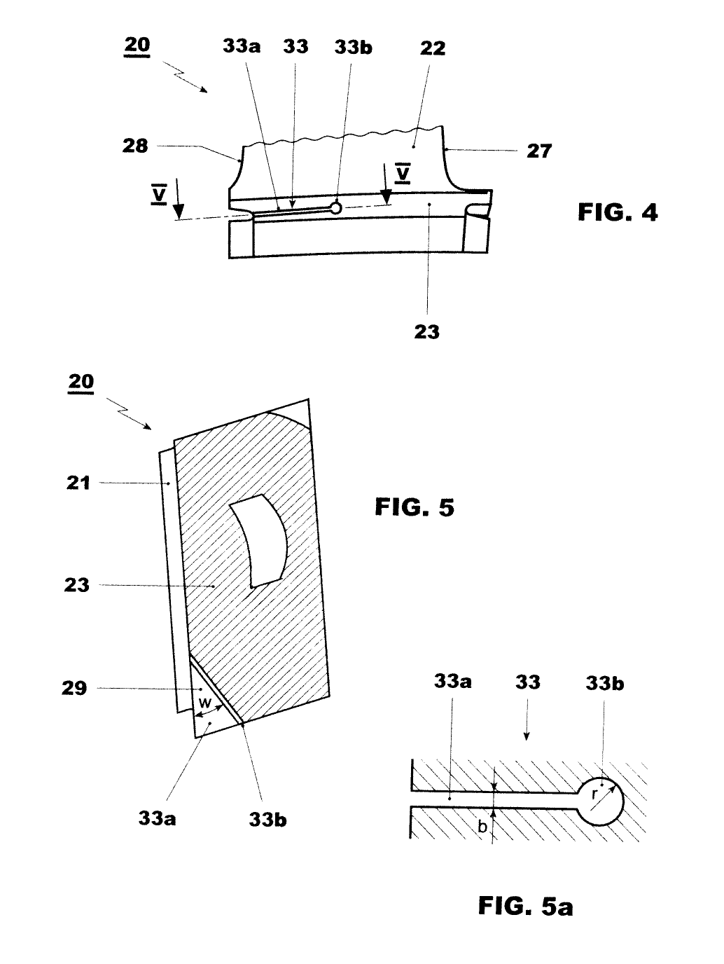

A slot 33 which can be seen more precisely in FIG. 4 is arranged in the inner platform 23 substantially parallel to the plane of the platform. According to FIG. 5a, the slot 33 has a keyhole-like cross-sectional profile with a wall section 33a (with parallel sides or walls) having the width b and a circular end section 33b with the radius r placed at the bottom of the slot 33. The width b of the wall section 33a is less than 1 mm, preferably about 0.4 mm, whereas the radius r of the end section 33b is greater than 1 mm, preferably about 1.25 mm. The aim with the dimensioning of the slot is to reduce the mechanical loading of the thermally bending inner platform 23 which acts on the trailing edge without producing stress concentrations at the bottom of the slot 33 and large volumes in the slot which could result in additional thermal stresses as a result of filling with cooling air.

As can be seen from FIG. 5, the inner platform has a four-cornered (in particular rhombic) base surface. The trailing edge 28 with the cooling slot 29 arranged in front leads into the inner platform 23 at one of the four corners (bottom left in FIG. 5). The slot 33 intersects this corner with a depth which ensures a sufficient distance of the slot bottom from the trailing edge, with the end section 33b of the slot 33 enclosing an acute angle w, in particular an angle between 30° and 40°, with the side walls of the inner platform 23.

What is preferable for the invention in the embodiment represented is a slot through the inner platform 23 which changes the stress flow resulting from thermal bending of the end part and relieves the thin trailing edge of the vane with the pressure-side edge cooling. The base line (end section 33b) of the slot is not perpendicular to the line of curvature of the trailing edge, and encloses an acute angle with the lateral surface of the inner platform 23 in order to compensate for the stresses at both ends of the slot, namely at the lateral surface and at the rear side. The slot has the cross-sectional contour of a “keyhole” in order to reduce the stresses at the bottom of the slot and to minimize the overall volume of the slot, because a large cavity filled with cooling air would increase the temperature gradient and hence the stresses at the trailing edge.

The invention can be used in all turbine guide vanes. Preferably, it is used in large stationary gas turbines with sequential combustion, such as, for example, the GT24/26 of the Assignee of the present invention, in the third guide vane row of the low pressure turbine.

As a result of the stress-reducing slot, it is possible to achieve the desired service life even with guide vanes having thin trailing edges, as are present in the case of pressure-side cooling through an integrated cooling slot.

### LIST OF REFERENCE SIGNS

10 Gas turbine
11 Compressor
12,16 Fuel supply
13 EV burner
14,17 Combustion chamber
15 High pressure turbine
18 Low pressure turbine
19 Axis
20,20′ Guide vane
21 Outer platform
22 Airfoil
23 Inner platform (shroud)
24,25 Mounting element (hook-like)
26 Sealing groove
27 Leading edge
28 Trailing edge
29 Cooling slot
30 Hot gas flow
31 Pressure side
32 Suction side
33 Slot
33a Wall section
33b End section (bore)
b Width (slot)
r Radius (end section)
w Angle

What is claimed is:

1. A guide vane (20), for a gas turbine (10), comprising an airfoil (22) extending in a radial direction between an inner platform (23) and an outer platform (21), wherein the airfoil (22) extends transversely to a hot gas flow (30) direction between a leading edge (27) and a trailing edge (28) and has a pressure side (31) and a suction side (32), and wherein a cooling slot (29) running parallel to the trailing edge (28) is provided on the pressure side (31) in front of the trailing edge (28), a cooling medium flows through the cooling slot out of the guide vane (20) over an entire length of the guide vane (20) and thus cools the trailing edge (28) of the guide vane (20), and wherein a thermal stress reducing element (33; 33a, 33b) is provided on the inner platform (23) below the trailing edge (28) and the cooling slot (29).

2. The guide vane as claimed in claim 1, wherein the thermal stress reducing element comprises a slot (33; 33a, 33b) running through the inner platform (23).

3. The guide vane as claimed in claim 2, wherein the slot (33; 33a, 33b) is oriented substantially parallel to the plane of the inner platform (23).

4. The guide vane as claimed in claim 3, wherein the slot (33; 33a, 33b) has a cross-sectional profile in the form of a keyhole, with a wall section (33a) with parallel sides and a round end section (33b) arranged at a bottom portion of the slot (33; 33a, 33b).

5. The guide vane as claimed in claim 3, wherein the slot (33; 33a, 33b) has a cross-sectional profile in the form of a keyhole, with a wall section (33a) with parallel sides and a circular end section (33b) arranged at a bottom portion of the slot (33; 33a, 33b).

6. The guide vane as claimed in claim 3, wherein the inner platform (23) has a four-cornered base surface, the trailing edge (28) with the cooling slot (29) arranged in front leads into the inner platform (23) at one of the four corners, and the slot (33; 33a, 33b) intersects this corner.

7. The guide vane as claimed in claim 6, wherein the end section (33b) of the slot (33, 33a, 33b) forms an acute angle (w) with the side walls of the inner platform (23).

8. The guide vane as claimed in claim 6, wherein the end section (33b) of the slot (33, 33a, 33b) forms an angle between 30° and 40° with the side walls of the inner platform (23).

9. The guide vane as claimed in claim 6, wherein the slot (33; 33a, 33b) has a width (b) of less than 1 mm in the region of the wall section (33a), and the end section (33b) is formed in a circular manner with a radius (r) of greater than 1 mm.

10. The guide vane as claimed in claim 9, wherein the slot (33; 33a, 33b) has a width (b) of about 0.4 mm in the region of the wall section (33a), and the end section (33b) is formed in a circular manner with a radius (r) of about 1.25 mm.

11. The guide vane as claimed in claim 1, wherein the cooling slot (29) is produced in the guide vane (20) by casting.

12. A gas turbine (10) with a guide vane as claimed in claim 1, wherein the guide vane (20) is arranged in a turbine (15, 18) of the gas turbine (10).

13. The gas turbine as claimed in claim 12, wherein the gas turbine (10) is a gas turbine with sequential combustion which has a first combustion chamber (14) with a downstream high pressure turbine (15) and a second combustion chamber (17) with a downstream low pressure turbine (18), and the guide vane (20) is arranged in the low pressure turbine (18).

14. The gas turbine as claimed in claim 13, wherein the low pressure turbine has a plurality of rows of guide vanes behind one another in a flow direction, and the guide vane (20) is arranged in a central guide vane row.
